(19) United States
(12) Patent Application Publication
(10) Pub. No.: US 2009/0046231 A1
(43) Pub. Date: Feb. 19, 2009

(54) DISPLAY PANEL AND FABRICATING METHOD THEREOF

(75) Inventors: Jhih-Ping Lu, Hsinchu Hsien (TW); Fu-Kang Chen, Taichung County (TW); Wen-Chun Chen, Taipei City (TW); Yuh-Zheng Lee, Hsinchu City (TW); Yuan-Chang Liao, Yunlin County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/014,797

(22) Filed: Jan. 16, 2008

(30) Foreign Application Priority Data
Aug. 14, 2007 (TW) 96129973

(51) Int. Cl. G02F 1/01; G02F 1/1333

(52) U.S. Cl. 349/139; 359/238; 359/291; 349/189

(57) ABSTRACT

A display panel including a substrate, a first electrode layer, a pixel definition layer, a liquid display medium, a cap layer, and a second electrode layer is provided. The first electrode layer is disposed on the substrate. The pixel definition layer is disposed on the first electrode layer, wherein the pixel definition layer has a plurality of openings arranged in array so as to expose a part of the first electrode layer. The liquid display medium is disposed within the openings. The cap layer is connected to the pixel definition layer and covers the liquid display medium, so as to envelop the liquid display medium in the openings. The second electrode layer is disposed on the cap layer. A method of fabricating the display panel is also provided. Accordingly, the thickness of the display panel is decreased and the process of fabricating the display panel is more easily controlled.

### CROSS-REFERENCE TO RELATED APPLICATION

This application claims the priority benefit of Taiwan application serial no. 96129973, filed on Aug. 14, 2007. The entirety of the above-mentioned patent application is hereby incorporated by reference herein and made a part of this specification.

### BACKGROUND OF THE INVENTION

1. Field of the Invention

The present invention relates to a display panel and a fabricating method thereof. More particularly, the present invention relates to a display panel having a liquid display medium and a fabricating method thereof.

2. Description of Related Art

In recent years, flexible displays, e-papers, and e-books are developing rapidly. Therefore, in the trend of large-scale flat-panel displays, displays having characteristics of being light, thin, and flexible will become a mainstream product in future market. The cholesteric LCD has a bi-stable characteristic, and needs an appropriate driving voltage just when updating frames, thus having the advantage of power-saving. Accordingly, the cholesteric liquid crystal is quite applicable to e-papers and e-books.

In the past, in order to achieve a full-color cholesteric LCD, three layers of cholesteric liquid crystal capable of reflecting different colors are stacked, and a complicated driving manner is adopted, so that the display may produce reflection of different colors. This method has disadvantages that the three-layer stacked structure may cause difficulties in aligning the panel and designing the electrode, and the fabricating process is complicate. Thus, the above method is not suitable to flexible displays, e-papers, and e-books.

To solve the above problems, U.S. Pat. No. 5,949,513 entitled “Methods of Manufacturing Multi-Color Liquid Crystal Displays Using in Situ Mixing Techniques” has disclosed a method of manufacturing multi-color LCDs using in situ mixing techniques. According to this method, a photo-decomposing twist agent is printed at a predetermined position. Then, cholesteric liquid crystal is filled in and mixed with the twist agent. After that, UV light is irradiated to change (usually reduce) the amount of the twist agent in each area, such that the LCD can display multiple colors. However, the display quality of such an LCD is prone to be affected by the UV light in the external environment, and thus an anti-UV coating is required for protection. Therefore, an extra fabricating process of anti-UV coating is needed, and the overall thickness of the display panel is increased accordingly.

Furthermore, U.S. Pat. No. 6,331,884 entitled “Method of Making a Liquid Crystal Device” has also disclosed a method of making a liquid crystal device. According to this method, a resin monomer is first coated on a plurality of insulating thin films. Next, a plurality of liquid crystal materials is formed by jet-printing process. Then a second substrate is covered on the liquid crystal materials to perform an exposure process such that a plurality of resin spacers are formed. This method has disadvantages that the overall thickness and fabricating process of the display panel are difficult to control.

In view of the above, although the prior arts intend to fabricate a display panel with the characteristics of being light, thin, and flexible, it is still difficult to carry out. Therefore, the problem that the overall thickness and fabricating process of the display panel are difficult to control is in urgent need of being solved.

### SUMMARY OF THE INVENTION

A display panel including a substrate, a first electrode layer, a pixel definition layer, a liquid display medium, a cap layer, and a second electrode layer is provided. The first electrode layer is disposed on the substrate. The pixel definition layer is disposed on the first electrode layer, wherein the pixel definition layer has a plurality of openings arranged in array so as to expose a part of the first electrode layer. The liquid display medium is disposed within the openings. The cap layer is connected to the pixel definition layer and covers the liquid display medium, so as to envelop the liquid display medium in the openings. The second electrode layer is disposed on the cap layer.

The present invention further provides a method of fabricating the display panel. First, a substrate is provided, and a first electrode layer is formed on the substrate. Next, a pixel definition layer having a plurality of openings is formed on the first electrode layer Then, a liquid display medium is filled into each opening and a cap layer is formed on the liquid display medium, such that the cap layer is connected to the pixel definition layer to envelop the liquid display medium in the openings. Afterward, a second electrode layer is formed on the cap layer.

In the present invention, as the cap layer is used to envelop the liquid display medium in the openings of the pixel definition layer, and the second electrode layer is formed on the cap layer, the thickness of the display panel is significantly decreased and the process of fabricating the display panel is more easily controlled.

In order to the make the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

The accompanying drawings are included to provide a further understanding of the invention, and are incorporated in and constitute a part of this specification. The drawings illustrate embodiments of the invention and, together with the description, serve to explain the principles of the invention.

FIGS. 1A to 1D are schematic cross-sectional views showing the fabricating processes of a display panel according to the first embodiment of the present invention.

FIG. 2 is a schematic view of a display panel according to the second embodiment of the present invention.

FIG. 3 is a schematic view of a display panel according to the third embodiment of the present invention.

### DESCRIPTION OF EMBODIMENTS

### The First Embodiment

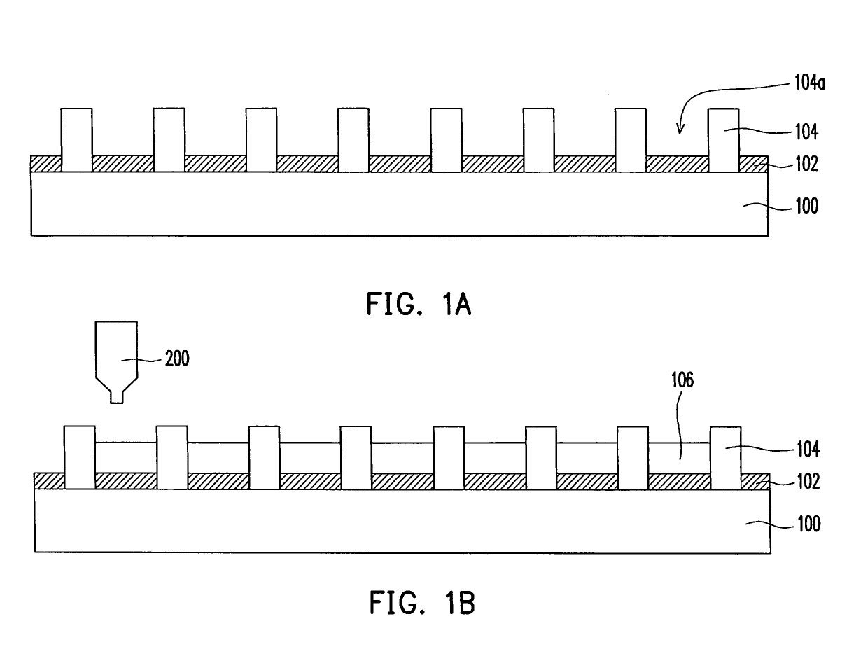

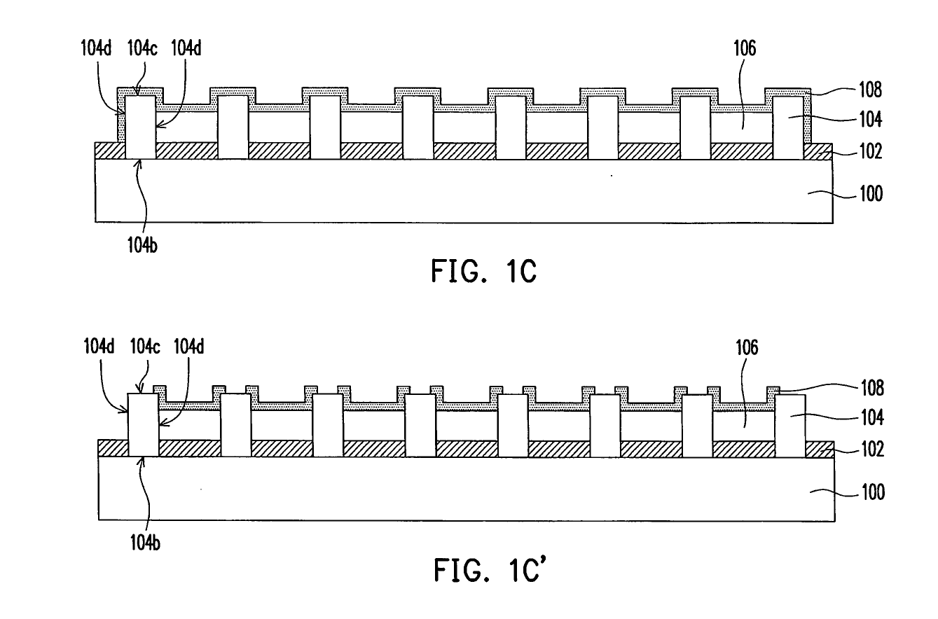

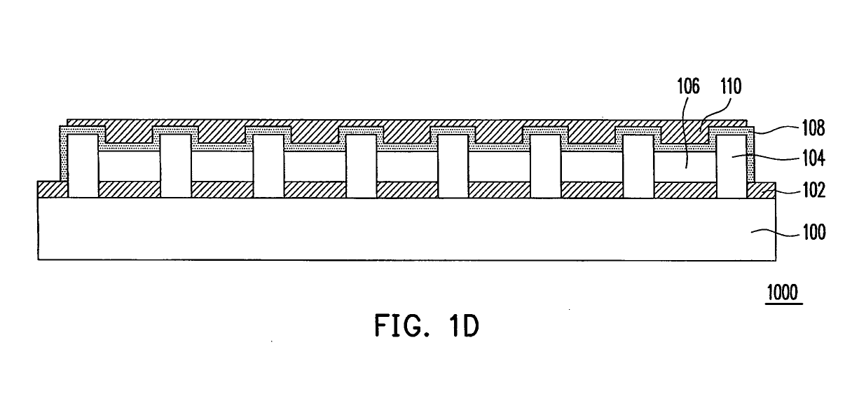

FIGS. 1A to 1D are schematic cross-sectional views showing the fabricating processes of a display panel according to the first embodiment of the present invention.

Referring to FIG. 1A, a substrate 100 is provided. In an embodiment of the present invention, the substrate 100 is a flexible substrate, for example, a polymer plastic substrate. However, in the present invention, the substrate 100 is not limited to the flexible substrate, but may also be a rigid substrate, such as a glass substrate. Then, a first electrode layer 102 is formed on the substrate 100, and the material of the first electrode layer 102 is, for example, an inorganic transparent conductive material. For example, the material of the first electrode layer 102 may be indium tin oxide (ITO) or indium zinc oxide (IZO). In an alternative embodiment, the material of the first electrode layer 102 may also be an organic conductive material, such as poly(3,4-ethylene dioxythiophene)/poly(styrene sulfonate), (PEDOT/PSS).

Next, a pixel definition layer 104 having a plurality of openings 104a arranged in array is formed on the first electrode layer 102 so as to expose a part of the first electrode layer 102. The pixel definition layer 104 is formed by, for example, photolithography and etching process, die-casting process, screen printing process, and/or ink-jet printing process. Taking the photolithography and etching process as an example, a material layer is formed on the first electrode layer 102, and the material of material layer is, for example, a melanin-containing polymer. Then, the photolithography and etching process is performed to pattern the material layer (e.g. the light sensitive layer), so as to form the pixel definition layer 104.

Referring to FIG. 1B, a liquid display medium 106 is printed in the openings 104a of the pixel definition layer 104. The liquid display medium is printed in the openings 104a through the ink-jet printing process with an inkjet nozzle 200. In an embodiment of the present invention, the liquid display medium 106 includes, for example, different cholesteric liquid crystals, such that the light source after passing through the different cholesteric liquid crystals and being partially reflected will present three colors of red, green, and blue, for example. In another embodiment of the present invention, the liquid display medium 106 may include a single kind of cholesteric liquid crystals, such that the light source after passing through the cholesteric liquid crystal and being partially reflected will present a single color.

Referring to FIG. 1C, a cap layer 108 is formed on the liquid display medium 106, such that the cap layer 108 is connected to the pixel definition layer 104 and covers the liquid display medium 106. As shown in FIG. 1C, the cap layer 108 envelops the liquid display medium 106 in the openings 104a of the pixel definition layer 104. The cap layer 108 may be formed by vapor deposition, such as chemical vapor deposition (CVD) or physical vapor deposition (PVD). In another embodiment of the present invention, the cap layer 108 entirely covers the pixel definition layer 104 and the liquid display medium 106. In detail, the pixel definition layer 104 has a bottom surface 104b, a top surface 104c, and a side surface 104d. The liquid display medium 106 is in contact with the cap layer 108 and the side surface 104d of the pixel definition layer 104. The cap layer 108 entirely covers the pixel definition layer 104 and the liquid display medium 106. In another embodiment of the present invention, the cap layer 108 may partially cover the pixel definition layer 104 and the liquid display medium 106 so as to expose a part of the pixel definition layer 104 (as shown in FIG. 1C′). in other words, the liquid display medium 106 and the cap layer 108 are in contact with the side surface 104d of the pixel definition layer 104. The cap layer 108 partially covers the liquid display medium 106 so as to expose a part of the top surface 104c and the side surface 104d of the pixel definition layer 104. Additionally, the material of the cap layer 108 is, for example, parylene.

Referring to FIG. 1D, a second electrode layer 110 is formed on the cap layer 108. After forming the second electrode layer 110, a display panel 1000 is substantially fabricated. It can be known from FIG. 1D that only a single sheet of the substrate 100 is used to fabricate the display panel 1000 of this embodiment, so the display panel 1000 is very thin.

According to another embodiment of the present invention, the above fabricating method further includes forming an alignment layer (not shown) on the first electrode layer 102, such that the cholesteric liquid crystal have the desired orientation. The material of the alignment layer includes polyvinyl alcohol, polyimide, polyamide, nylon, silicon dioxide, or lecithin.

In view of the above, the display panel 1000 of this embodiment includes a substrate 100, a first electrode layer 102, a pixel definition layer 104, a liquid display medium 106, a cap layer 108, and a second electrode layer 110. The first electrode layer 102 is disposed on the substrate 100. The pixel definition layer 104 is disposed on the first electrode layer 102, wherein the pixel definition layer 104 has a plurality of openings 104a arranged in array, so as to expose exposing a part of the first electrode layer 102. The liquid display medium 106 is disposed within the openings 104a. The cap layer 108 is connected to the pixel definition layer 104 and covers the liquid display medium 106, so as to envelop the liquid display medium 106 in the openings 104a. The second electrode layer is disposed on the cap layer 108.

In an alternative embodiment of the present invention, the first electrode layer 102 of the display panel 1000 includes a plurality of parallel first stripe electrodes (not shown). The second electrode layer 110 of the display panel 1000 includes a plurality of parallel second stripe electrodes (not shown). The extending direction of the first stripe electrodes is substantially perpendicular to that of the second stripe electrodes. In other words, the display panel 1000 is a passive display panel.

### The Second Embodiment

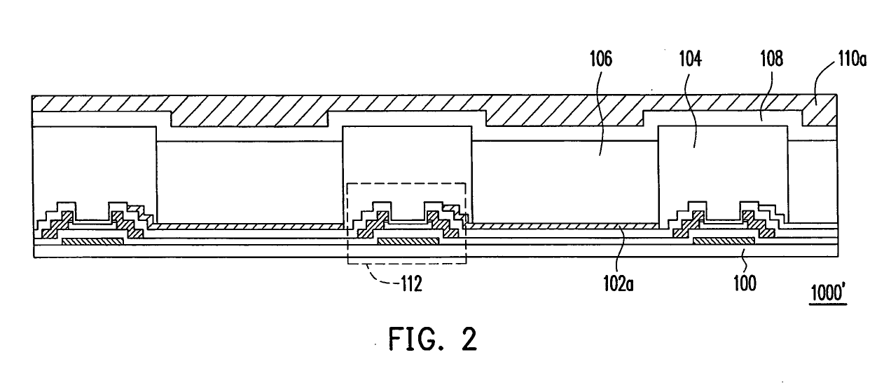

FIG. 2 is a schematic view of a display panel according to the second embodiment of the present invention. Referring to FIG. 2, the display panel 1000′ of this embodiment further includes a plurality of active devices 112 arranged in array. The first electrode layer 102 of the display panel 1000′ are a plurality of pixel electrodes 102a electrically connected to the corresponding active devices 112, for example. The second electrode layer 110 of the display panel 1000′ is a common electrode 110a, for example. In other words, the display panel 1000′ is an active display panel. The active devices 112 include a-Si TFTs, poly-Si TFTs, bipolar transistors, or other three-terminal active devices.

It should be noted that although the active devices 112 shown in FIG. 2 are disposed below the pixel definition layer 104, the active devices 112 may also be disposed on other positions. For example, the active devices 112 may be partially disposed below the pixel definition layer 104 and partially disposed inside the pixels (i.e., below the liquid display medium 106), or the active devices 112 may also be completely disposed inside the pixels.

### The Third Embodiment

In the first and second embodiments, an active or a passive LCD panel is taken as an example for illustration. However, the type of the liquid display medium 106 is not limited in the present invention, and an electrowetting display panel is described below.

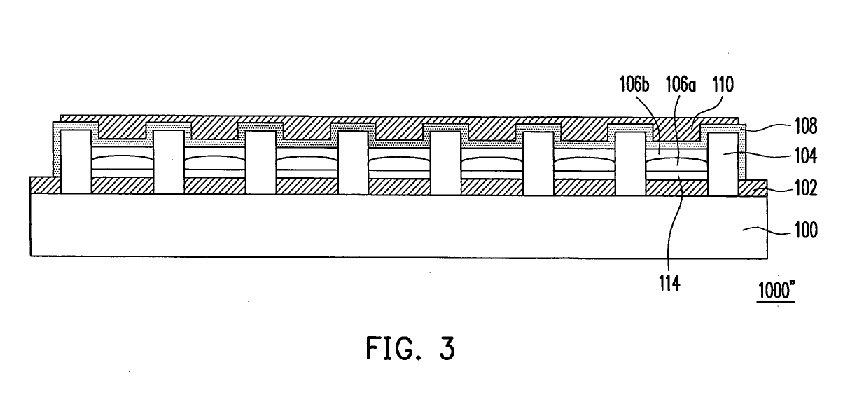

FIG. 3 is a schematic view of a display panel according to the third embodiment of the present invention. Referring to FIG. 3, the display panel 1000″ of this embodiment is similar to the display panel 1000 of the first embodiment, and the major difference of the two is described as follows. The liquid display medium 106 in the display panel 1000″ of this embodiment is an electrowetting display medium, and the display panel 1000″ of this embodiment further includes at least one hydrophobic material layer 114.

As shown in FIG. 3, the hydrophobic material layer 114 is disposed on the first electrode layer 102 exposed by the openings 104a. Furthermore, the electrowetting display medium includes a hydrophobic liquid 106a and a hydrophilic liquid 106b. The hydrophobic liquid 106a is disposed on the hydrophobic material layer 114, and the hydrophilic liquid 106b encapsulates the hydrophobic liquid 106a. In a preferred embodiment, the hydrophobic liquid 106a has red, green, blue, or other colors. The contact area of the hydrophobic liquid 106a and the hydrophobic material layer 114 varies with the change of the electric field between the first electrode layer 102 and the second electrode layer 110, thus presenting colors of different grayscales.

In the present invention, the cap layer is used to envelop the liquid display medium, such that the difficulty in forming an electrode on the liquid display medium can be effectively solved. Moreover, the cap layer for enveloping the liquid display medium has a small thickness and is easy to fabricate, so that the overall thickness of the display panel can be effectively decreased without raising the cost. On the other hand, it contributes to the fabrication of a flexible display panel by adopting the cap layer to envelop the liquid display medium.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the appended claims and their equivalents.

What is claimed is:

1. A display panel, comprising:
a substrate;
a first electrode layer, disposed on the substrate;
a pixel definition layer, disposed on the first electrode layer, wherein the pixel definition layer has a plurality of openings arranged in array so as to expose a part of the first electrode layer;
a liquid display medium, disposed within the openings;
a cap layer, connected to the pixel definition layer and covers the liquid display medium, so as to envelop the liquid display medium in the openings; and
a second electrode layer, disposed on the cap layer.

2. The display panel as claimed in claim 1, wherein the substrate is a flexible substrate or a rigid substrate.

3. The display panel as claimed in claim 1, wherein a material of the cap layer is formed by PVD or CVD.

4. The display panel as claimed in claim 1, wherein a material of the cap layer comprises parylene.

5. The display panel as claimed in claim 1, wherein the pixel definition layer has a bottom surface, a top surface, and a side surface, and the liquid display medium and the cap layer are in contact with the side surface.

6. The display panel as claimed in claim 5, wherein the cap layer is in contact with the top surface.

7. The display panel as claimed in claim 1, wherein the liquid display medium comprises cholesteric liquid crystal.

8. The display panel as claimed in claim 1, wherein the liquid display medium comprises an electrowetting display medium.

9. The display panel as claimed in claim 8, further comprising at least one hydrophobic material layer disposed on the first electrode layer exposed by the openings.

10. The display panel as claimed in claim 8, wherein the electrowetting display medium comprises:
a hydrophobic liquid, disposed on the hydrophobic material layer; and
a hydrophilic liquid, encapsulating the hydrophobic liquid, wherein a contact area of the hydrophobic liquid and the hydrophobic material layer varies with a change of an electric field between the first electrode layer and the second electrode layer.

11. The display panel as claimed in claim 1, wherein the first electrode layer comprises a plurality of parallel first stripe electrodes, the second electrode layer comprises a plurality of parallel second stripe electrodes, and an extending direction of the first stripe electrodes is substantially perpendicular to that of the second stripe electrodes.

12. The display panel as claimed in claim 1, further comprising a plurality of active devices arranged in array, wherein the first electrode layer comprises a plurality of pixel electrodes, each of the pixel electrodes is electrically connected to one of the active devices correspondingly, and the second electrode layer comprises a common electrode.

13. A method of fabricating a display panel, comprising:
providing a substrate;
forming a first electrode layer on the substrate;
forming a pixel definition layer having a plurality of openings on the first electrode layer;
filling a liquid display medium into the openings;
forming a cap layer on the liquid display medium, such that the cap layer is connected to the pixel definition layer to envelop the liquid display medium in the openings; and
forming a second electrode layer on the cap layer.

14. The method of fabricating the display panel as claimed in claim 13, wherein the substrate is a flexible substrate or a rigid substrate.

15. The method of fabricating the display panel as claimed in claim 13, wherein a material of the cap layer comprises parylene.

16. The method of fabricating the display panel as claimed in claim 13, wherein a method of forming the cap layer comprises:
forming a material layer; and
patterning the material layer to form the cap layer, wherein the cap layer covers the pixel definition layer and the liquid display medium entirely.

17. The method of fabricating the display panel as claimed in claim 13, wherein a method of forming the cap layer comprises:
forming a material layer; and
patterning the material layer to form the cap layer, wherein the cap layer covers the pixel definition layer and the liquid display medium so as to expose a part of the pixel definition layer.

18. The method of fabricating the display panel as claimed in claim 13, wherein the liquid display medium comprises cholesteric liquid crystal.

19. The method of fabricating the display panel as claimed in claim 13, wherein the liquid display medium comprises electrowetting display medium.

20. The method of fabricating the display panel as claimed in claim 19, further comprising forming at least one hydrophobic material layer on the first electrode layer exposed by the openings.

21. The method of fabricating the display panel as claimed in claim 13, wherein a method of forming the cap layer comprises vapor deposition.

22. The method of fabricating the display panel as claimed in claim 13, wherein a method of forming the pixel definition layer comprises photolithography and etching process, die-casting process, screen printing process, or ink-jet printing process.

23. The method of fabricating the display panel as claimed in claim 13, wherein a method of filling the liquid display medium into the openings comprises ink-jet printing process.
